(19) United States
(12) Patent Application Publication
(10) Pub. No.: US 2002/0154630 A1
(43) Pub. Date: Oct. 24, 2002

(54) Switching center and central switching controller with internal broadband bus

(76) Inventor: Gonzalo Lucioni, Witten (DE)

Correspondence Address: Bell, Boyd & Lloyd LLC, P.O. Box 1135, Chicago, IL, 60690-1135, US

(21) Appl. No.: 10/131,548

(22) Filed: Apr. 23, 2002

(30) Foreign Application Priority Data
Apr. 24, 2001 (DE) 101 200 73.0

(51) Int. Cl. H04L 12/50

(52) U.S. Cl. 370/386; 370/463

(57) ABSTRACT

A switching center is provided which has an internal broadband bus having broadband interfaces coupling both peripheral devices and internal system components of the switching center. In addition, a data packet communications protocol is provided which can be used for the direct and specifically directed transfer of communication data, which are to be relayed over connections, via the broadband bus between a respective peripheral device and a respective internal system component and also between the peripheral devices themselves.

### BACKGROUND OF THE INVENTION

Contemporary switching centers generally have a central processor-assisted control assembly (central board) to which various peripheral assemblies and internal system components of the switching center are connected via special hardware interfaces. The peripheral assemblies can be used to connect external communications devices, such as communications terminals, communications networks and/or data networks. Depending on the type of external communications device to be connected, a respective peripheral assembly requires a functionality which is specific to this type. By way of example, a peripheral assembly for connecting a local area network (LAN) frequently requires functionalities for narrowband LAN networking using ISDN (Integrated Services Digital Network), for implementing access to telematics services, such as fax or file transfer, for computer-assisted telephony (CTI: Computer Telephony Integration) and/or for voice transmission using the Internet protocol (VOIP: Voice over IP).

To support a functionality which is specific to a respective external communications device, a respective peripheral assembly holds specific static hardware components which are designed specifically for the respective functionality and can be used only as such. Such peripheral assemblies make it possible to provide a specific, but limited, functionality efficiently in each case.

However, this concept does not readily allow the functionality or the hardware resources of a peripheral assembly or of an internal system component to be extended on a modular basis. Another shortcoming of this known concept is that the hardware resources of a peripheral assembly cannot be used by other peripheral assemblies. Instead, the available hardware resources are statically associated with the peripheral assemblies or with the internal system components.

It is an object of the present invention to specify a switching center for switching connections between communications devices which allows hardware resources to be flexibly allocated and extended. It is also an object to specify a central switching controller for such a switching center.

### SUMMARY OF THE INVENTION

A switching center in accordance with the present invention has an internal broadband bus having broadband interfaces to which peripheral devices and internal system components of the switching center can be coupled. The peripheral devices of the switching center are used for connecting external communications devices, such as communications terminals for voice, video or data communication, fax machines, personal computers or continuing communications networks between which connections need to be switched by the switching center. Examples of internal system components are system processors, switching matrix modules, digital signal processors or memory chips.

To use the broadband bus to transfer communication data which are to be relayed over the connections, a data packet communications protocol is provided. The form of the data packet communications protocol is such that the communication data can be transferred directly and in specifically directed fashion via the broadband bus between a respective peripheral device and a respective internal system component and also between the peripheral devices themselves. In this case, the communication data are transferred in the form of data packets.

A fundamental advantage of the present invention is that it is possible to transfer both communication data from broadband applications, such as video or database applications, and communication data from narrowband applications, such as telephony connections, using the same broadband bus. Internal system components of the inventive switching center which are coupled to the broadband bus, therefore, can be used both by narrowband connections and by broadband connections. Thus, by way of example, a digital signal processor available as an internal system component can be used both for narrowband applications and for broadband applications, possibly together. As such, the inventive concept provides a particularly simple way of linking broadband applications and narrowband applications.

Another advantage of the present invention is that the data packet communications protocol can be used to transfer communication data from a peripheral device directly and in specifically directed fashion to another peripheral device coupled to the broadband bus. As such, it is possible to transfer, by way of example, voice data originating in a terminal from that peripheral device to which the terminal in question is coupled, via the broadband bus directly to a peripheral device to which a local area network (LAN) having a personal computer as transfer destination for the voice data is coupled. In this context, the data packet communications protocol undertakes part of a route selection functionality for the voice data connection.

The peripheral devices can use the broadband bus to interchange communication data with different internal system components in each case. Thus, a respective peripheral device can use different functionalities of various internal system components as required in each case. Thus, the inventive switching center can be flexibly extended on a modular basis by adding further system components, and new functionalities can easily be retrofitted. As a result of their being coupled to the broadband bus, added system components can, in principle, be used by all peripheral devices coupled to the broadband bus.

In accordance with one advantageous embodiment of the present invention, the broadband bus can be integrated in a central switching controller in the switching center. The broadband interface of the broadband bus then can be used to couple the peripheral devices and internal system components of the switching center to the central switching controller.

In accordance with another embodiment of the present invention, an internal system component used can be an allocation module for allocating system resources of at least one internal system component to at least one peripheral device. The allocation is preferably made dynamically and in a manner oriented to requirements. As such, by way of example, the functionality of a digital signal processor for voice coding can be allocated to different peripheral devices for temporary use as required.

In accordance with another embodiment, at least one of the broadband interfaces is in the form of a generic or application-neutral interface. This favors flexible extension of the switching center using various new system components or peripheral devices. Preferably, a standardized hardware interface or hardware-analogous interface can be provided.

In accordance with a further embodiment of the present invention, a data memory for buffer-storing data which are to be transferred via the broadband bus can be coupled to the broadband bus. The data memory can temporarily buffer-store data which are to be transferred and which cannot currently be accepted by their respective transfer destination, so that the broadband bus is not blocked during this period of time. The buffer function of such a data memory makes it possible to decouple the times of sending and receiving the data which are to be transferred via the broadband bus. To control the transfer and/or buffering of the data, it is possible to provide a bus control unit, a “bus controller.”

In addition, a processor for processing data which are to be transferred via the broadband bus can be coupled to the broadband bus as an internal system component.

A switching matrix module for switching the communication data which are to be transferred via the broadband bus also can be coupled to the broadband bus as an internal system component.

In accordance with one advantageous embodiment of the present invention, the data packet communications protocol can provide direct addressing, related to the broadband bus, both for the internal system components and for the peripheral devices. The route selection for the data packets which are to be transferred via the broadband bus can then be made on the basis of an item of address information contained in the respective data packets. Preferably, the data packet communications protocol implemented can be an Internet protocol; e.g., from the TCP/IP family. In particular, it is possible to use a data packet communications protocol situated on the second or third layer of the OSI reference model.

Preferably, the broadband bus can be a “PCI bus” (Peripheral Component Interconnect).

Additional features and advantages of the present invention are described in, and will be apparent from, the following Detailed Description of the Invention and the Figures.

### BRIEF DESCRIPTION OF THE FIGURES

FIG. 1 shows a schematic illustration of a switching center connected to various communications devices.

### DETAILED DESCRIPTION OF THE INVENTION

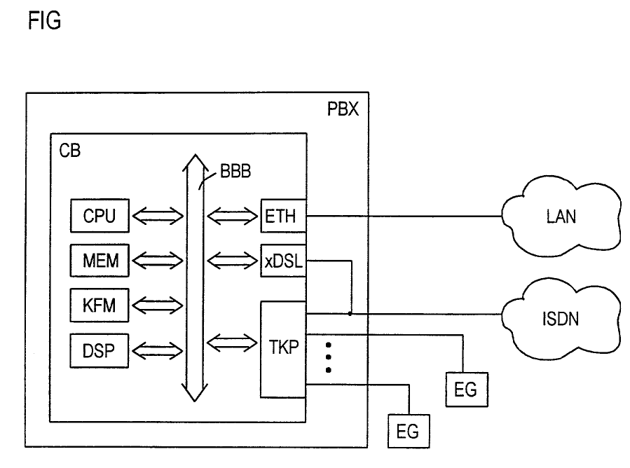

FIG. 1 is a schematic illustration of a switching center PBX, such as a private branch exchange, which is connected to a public communications network ISDN. Also coupled to the switching center PBX are a local area network LAN and a number of communications terminals EG. By way of example, the terminals EG can be terminals for voice, video and/or data communication, fax terminals or personal computers.

The switching center PBX contains, as central switching controller, a central switching assembly CB which is preferably in the form of a “central board.” For its part, the central switching assembly CB has, as peripheral devices, a telecommunications peripheral group TKP for narrowband communication, a LAN assembly ETH and an xDSL assembly xDSL. The peripheral group TKP is used to couple the public communications network ISDN and the terminals EG, in each case using narrowband interfaces. The LAN assembly ETH, such as an “Ethernet” or “Token Ring” assembly, is used to connect the local area network LAN, which thus allows broadband networking of the switching center PBX with other communications and/or data processing devices connected to the local area network LAN.

The xDSL assembly xDSL is likewise coupled to the public communications network ISDN. The xDSL assembly xDSL provides broadband access, such as to the Internet, which is routed via the cabling of the public communications network ISDN. The abbreviation xDSL signifies different variants of a broadband transfer technology in which existing telephone lines are used as a transfer medium. Common representatives of these access technologies are ADSL (Asymmetric Digital Subscriber Line) and HDSL (High Bit Rate Digital Subscriber Line).

The central switching assembly CB also has a broadband bus BBB to which the LAN assembly ETH, the xDSL assembly xDSL and the peripheral group TKP are connected, in each case via generic and function-neutral broadband interfaces. In this connection, in line with ITU-T recommendation I.113, a broadband bus is understood to be a data bus whose data transfer rate exceeds the “primary multiplex rate” of 2.048 Mbit/sec. The broadband bus BBB can be produced using standardized components, such as by a PCI bus (Peripheral Component Interconnect), or using “embedded components.” Preferably, these two component designs can be combined with one another in order to produce a more flexible architecture.

The central switching assembly CB also has a processor CPU, a switching matrix module KFM and a digital signal processor DSP as internal system components. The internal system components are connected to the broadband bus BBB likewise via generic, function-neutral broadband interfaces. The peripheral devices and internal system components which are or can be connected to the broadband bus BBB are referred to by the collective term modules below.

The broadband interfaces which connect the modules to the broadband bus BBB are preferably achieved by standardized hardware, or at least hardware-analogous, interfaces. The use of generic and function-neutral broadband interfaces allows for the switching center PBX to be easily extended by new functionalities on a modular basis by connecting an appropriate additional module to the broadband bus BBB. Such a newly connected module can immediately communicate with all other modules connected to the broadband bus BBB and can thus add its additional functionality. To simplify retrofitting with new modules, these can be in the form of plug-in cards.

In addition, the broadband bus BBB has a memory MEM connected to it which is used for buffer-storing data which are to be transferred via the broadband bus BBB and which cannot immediately be accepted by their respective transfer destination. The buffer-storage prevents data which are not accepted immediately from occasionally blocking the broadband bus BBB.

Data are transferred via the broadband bus BBB on a packet-oriented basis. For this purpose, the “IP protocol” (IP: Internet Protocol) from the TCP/IP protocol family is preferably implemented as the data packet communications protocol. Under this IP protocol, data which are to be transferred via the broadband bus BBB are converted into data packets which are provided with an item of address information which identifies the respective transfer destination on the broadband bus BBB. This allows data to be transferred directly and in specifically directed fashion between any modules coupled to the broadband bus BBB; i.e., in the present exemplary embodiment between the processor CPU, the switching matrix module KFM, the signal processor DSP, the LAN assembly ETH, the xDSL assembly xDSL, the peripheral group TKP and the memory MEM. In this case, the respective transfer destination of the data packets identifies the data packets as being addressed to itself on the basis of the contained item of address information and extracts them from the broadband bus BBB. The modules coupled to the broadband bus BBB can therefore specifically transfer among one another both communication data needing to be transmitted between the local area network LAN and/or the public communications network ISDN and/or the terminals EG, and control data for controlling individual modules or for requesting their processing resources. Thus, by way of example, communication data can be transferred by the LAN assembly ETH, the xDSL assembly xDSL and/or the peripheral group TKP to the signal processor DSP so that they can be subjected to digital processing there before they are forwarded. The processing resources of the signal processor DSP can thus be used by various modules in parallel; e.g., within the context of multimedia applications or encryption and security technologies. This applies similarly to the processor CPU and to the switching matrix module KFM.

The switching matrix module KFM is fundamentally used to allocate communication data arriving on a communications channel to an outgoing communications channel specific to a connection. For this purpose, the arriving communication data are transmitted to the switching matrix module KFM via the broadband bus BBB so that the switching matrix module can allocate them to an output channel and, again via the broadband bus BBB, transfer them to the appropriate peripheral module.

Particularly in relatively large switching centers, it is also possible for a number of switching matrix modules to be coupled to the broadband bus BBB on a modular basis. In this case, the IP protocol implemented on the broadband bus BBB can provide part of the route selection functionality for connections which are to be switched by virtue of the specifically directed transfer of communication data to the respectively appropriate switching matrix module.

As a result, the resources for broadband and narrowband applications are available to all modules coupled to the broadband bus BBB on the basis of specific requirements and applications and can be flexibly extended by retrofitting new modules. The inventive concept also can be used with backward compatibility.

The present invention incorporates both broadband applications and narrowband applications into a shared hardware architecture which can be uniformly extended on a modular basis. The shared hardware architecture makes it a simple matter for narrowband applications and broadband applications to be linked and to access shared processing resources. In addition, the inventive hardware architecture has a high performance level and can be scaled to switching centers of a wide variety of sizes.

In the present exemplary embodiment, the local area network LAN can be coupled via the xDSL assembly xDSL on a broadband basis to the public communications network ISDN and, hence, to external personal computers or to other local area networks via the Internet, for example. In addition, the switching center PBX can advantageously be used in computer-assisted telephony applications (Computer Telephony Integration, CTI) or for “Voice over IP” applications.

Although the present invention has been described with reference to specific embodiments, those of skill in the art will recognize that changes may be made thereto without departing from the spirit and scope of the present invention without departing from the hereafter appended claims.

1. A switching center for switching connections between communications devices, comprising:
peripheral devices for coupling the communications devices;
internal system components for controlling the switching center;
an internal broadband bus having broadband interfaces for coupling the peripheral devices and the internal system components; and
a data packet communications protocol for a direct and specifically directed transfer, routed via the broadband bus, of communication data, which are to be relayed over the connections, between a respective peripheral device and a respective internal system component and also between the peripheral devices themselves.

2. A switching center for switching connections between communications devices as claimed in claim 1, wherein the broadband bus is integrated in a central switching controller.

3. A switching center for switching connections between communications devices as claimed in claim 1, further comprising an allocation module, used as an internal system component, for allocating system resources of at least one internal system component to at least one peripheral device.

4. A switching center for switching connections between communications devices as claimed in claim 1, wherein at least one of the broadband interfaces is a generic interface.

5. A switching center for switching connections between communications devices as claimed in claim 1, further comprising a data memory, for buffer-storing data which are to be transferred via the broadband bus, coupled to the broadband bus.

6. A switching center for switching connections between communications devices as claimed in claim 1, further comprising a processor for processing data, which are to be transferred via the broadband bus, coupled to the broadband bus as an internal system component.

7. A switching center for switching connections between communications devices as claimed in claim 1, further comprising a switching matrix module, for switching the communication data, coupled to the broadband bus as an internal system component.

8. A switching center for switching connections between communications devices as claimed in claim 1, wherein the data packet communications protocol provides direct addressing, related to the broadband bus, both for the internal system components and for the peripheral devices.

9. A switching center for switching connections between communications devices as claimed in claim 8, wherein the data packet communications protocol is an Internet protocol.

10. A switching center for switching connections between communications devices as claimed in claim 1, wherein the broadband bus is a PCI bus.

11. A central switching controller for coupling peripheral devices and internal system components in a switching center provided for switching connections between communications devices, comprising:
an internal broadband bus having broadband interfaces for coupling the peripheral devices and the internal system components; and
a data packet communications protocol for a direct and specifically directed transfer, routed via the broadband bus, of communication data, which are to be relayed over the connections, between a respective peripheral device and a respective internal system component and also between the peripheral devices themselves.
